(19) United States
(12) Patent Application Publication
(10) Pub. No.: US 2015/0031284 A1
(43) Pub. Date: Jan. 29, 2015

(54) RADIO COMMUNICATION SYSTEM AND COMMUNICATION METHOD

(71) Applicant: NEC CORPORATION, Tokyo (JP)

(72) Inventors: Boonsarn Pitakdumrongkija, Tokyo (JP); Yoshikazu Kakura, Tokyo (JP); Naoto Ishii, Tokyo (JP)

(73) Assignee: NEC CORPORATION, Tokyo (JP)

(21) Appl. No.: 14/380,305

(22) PCT Filed: Feb. 21, 2013
(86) PCT No.: PCT/JP2013/000972

§ 371 Date: Aug. 21, 2014

(30) Foreign Application Priority Data
Feb. 24, 2012 (JP) 2012-038495

(51) Int. Cl. H04W 16/26; H04W 24/02

(52) U.S. Cl. CPC H04W 16/26; H04W 24/02
USPC 455/9

(57) ABSTRACT

A communication system and method that can minimize interference between RN-access links and can maximize the capacity of RNs in the network is provided. The communication system has a plurality of communication nodes which includes a base station and a plurality of relay nodes, wherein the base station controls the relay nodes, each of which can provide a radio connection to at least one terminal via an access link, wherein the base station signals each of the relay nodes to report measurement information related to the access link.

### TECHNICAL FIELD

The present invention relates to a radio communication system employing relay nodes, and more particularly to techniques of acquiring radio channel quality in the radio communication system.

### BACKGROUND

3GPP (3rd Generation Partnership Project) LTE-Advanced (Long Term Evolution Advanced) Work Item develops a relay node (hereafter referred to as RN) for deployment in a cellular network. One of the main objectives for deploying RNs is to enhance coverage area of a base station by improving throughput of a mobile station (user terminal) that locates in a coverage hole or far from the base station (see NPL1). Hereafter, a base station is referred to as BS or eNB (evolved Node B) and a mobile station or user terminal is referred to as UE (user equipment).

In the cellular network with RNs, eNB that can provide radio connection to a RN is called Donor eNB, which is hereafter denoted by DeNB. Note that, in this description, the terms eNB and DeNB are distinguished such that eNB is a base station without any RN connecting to it and DeNB is a base station with RN connecting to it. The radio connection between the DeNB and RN is called a backhaul link (or Un interface). Moreover, the term DeNB-UE is used for referring to UE that establishes a radio connection with DeNB, and the term RN-UE is used for referring to UE that establishes a radio connection with RN. The radio connection between DeNB and DeNB-UE is referred to as DeNB-access link, and the radio connection between RN and RN-UE is referred to as RN-access link (or Uu interface). Currently, 3GPP RAN Working Groups (RAN WGs) are mainly considering a RN called Type1 RN that shares common radio resources among the DeNB-access link, RN-access link, and backhaul link. In order to prevent self-interference at the Type1 RN between the backhaul and RN-access links, both links are time-division multiplexed by semi-statically configuring time-domain radio resources called backhaul subframes, that only allow communication between DeNB and RN (see NPL2 and NPL3).

As shown in FIG. 1, it is assumed that the cellular network is composed of a DeNB 10 controlling a macro-cell (donor-cell) 11 and multiple relay nodes (RN1, RN2) each controlling a relay-cell. In downlink communication, when multiple RNs transmit data to their RN-UEs at the same time, interference between RN-access links occurs. This can limit capacity of the RN. In order to solve this problem, the backhaul subframe coordination method as in NPL4 can be applied. In specific, NPL4 discloses the relay network in which the DeNB coordinates timing allocation for transmitting backhaul link data to each of the multiple RNs (hereafter referred to as backhaul subframe configuration applied at the RN) such that the backhaul subframe timings are differentiated. Therefore, each RN can have different timings compared with the other RNs, for receiving and transmitting the backhaul and RN-access link data, respectively, allowing the interference between RN-access links in the network to be reduced.

There are multiple ways to coordinate backhaul subframe configurations applied at the RNs. Therefore, the amount of interference between RN-access links that can be reduced and the capacity of the RN vary. In order to maximize the capacity of the RN, the DeNB 10 requires information related to interference level between RN-access links, so that it can estimate and compare the amount of reduced interference resulting from different backhaul subframe coordination.

Currently, the method for acquiring wireless channel quality in the Type1 relay network is disclosed in NPL5. In specific, NPL5 discloses the procedure for either the DeNB 10 or a RN to acquire radio channel quality measured by its UE. Since the procedures between DeNB 10 and DeNB-UE, and between RN and RN-UE are identical and inter-changeable, the following explanation will focus only on the procedure between RN and RN-UE.

Referring to FIG. 2, the RN initiates the radio channel quality measurement at the RN-UE with a RRC (Radio Resource Control) signaling. The RRC signaling can specify measurement type (Reference Signal Received Power (RSRP) or Reference Signal Received Quality (RSRQ)), measurement object (Cell-ID of communication node of interest), and reporting criteria (periodical or event-triggered). Then, the RN-UE performs the radio channel quality measurement based on the RRC signaling, and finally sends the result to the RN.

### CITATION LIST

### Non Patent Literature

### [NPL 1]

RP-100953, “Work item description: Relays for LTE,” 3GPP

### [NPL 2]

TR 36.814 v9.0.0, “E-UTRA: Further advancements for E-UTRA physical layer aspects (Release 9),” 3GPP

### [NPL 3]

TS 36.300 v10.4.0, “E-UTRA and E-UTRAN: Overall description, Stage 2 (Release 10),” 3GPP

### [NPL 4]

Y. Yuda, A. Iwata, and D. Imamura, “Interference mitigation using coordinated backhaul timing allocation for LTE-Advanced relay systems,” ICC 2011, IEEE

### [NPL 5]

TS 36.214 v10.1.0, “E-UTRA: Physical layer, Measurements (Release 10),” 3GPP

### SUMMARY

### Technical Problem

However, the procedure of radio channel quality measurement performed by the RN-UE is independent from the control of the DeNB 10 and information related to interference levels between RN-access links is only available at the RN. When the method in NPL5 is used for obtaining the interference level between RN-access links, the RN signals the RN-UE to measure the RSRP from adjacent RNs and the RN-UE will send the measurement report only to the RN. Although information on the interference level between RN-access links is required to determine the optimum backhaul subframe coordination that maximizes the capacity of the RN, the DeNB 10 cannot acquire such information. According to the method in NPL5, the DeNB 10 cannot estimate and minimize interference level between RN-access links.

The present invention has been accomplished in consideration of the above mentioned problems, and an object thereof is, to provide a radio communication system and a communication method that can minimize interference between RN-access links and can maximize the capacity of RNs in the network.

### Solution to Problem

According to the present invention, a communication system has a plurality of communication nodes which includes a base station and a plurality of relay nodes, wherein the base station controls the relay nodes, each of which can provide a radio connection to at least one terminal via an access link, wherein the base station signals each of the relay nodes to report measurement information related to the access link.

According to the present invention, a communication method in a communication system has a plurality of communication nodes which includes a base station and a plurality of relay nodes, wherein the base station controls the relay nodes, each of which can provide a radio connection to at least one terminal via an access link, the communication method comprising: at the base station, signaling each of the relay nodes to report measurement information related to the access link; and receiving a report on the measurement information from each relay node.

According to the present invention, a relay node device in a communication system comprising a plurality of communication node devices including a base station and a plurality of relay node devices, includes: a first radio communication section for providing a first radio connection to the base station via a first link; a second radio communication section for providing a second radio connection to at least one terminal via a second link; and a controller for generating a report on measurement information related to the second link and sending the report to the base station according to signaling from the base station. A terminal device in a communication system comprising a plurality of communication node devices including a base station and a plurality of relay node devices, includes: a radio communication section for providing a radio connection to a relay node device via an access link; a controller for generating measurement information related to the access link and sending the measurement information to the relay node device in response to a request received from the relay node controlled by the base station.

### Advantageous Effects of Invention

As described above, according to the present invention, it is possible to achieve a radio communication system and a communication control method that can minimize interference between RN-access links and can maximize the capacity of RNs in the network.

### BRIEF DESCRIPTION OF DRAWINGS

FIG. 1 is a schematic diagram of an illustrative configuration of a radio communication system employing a conventional communication control.

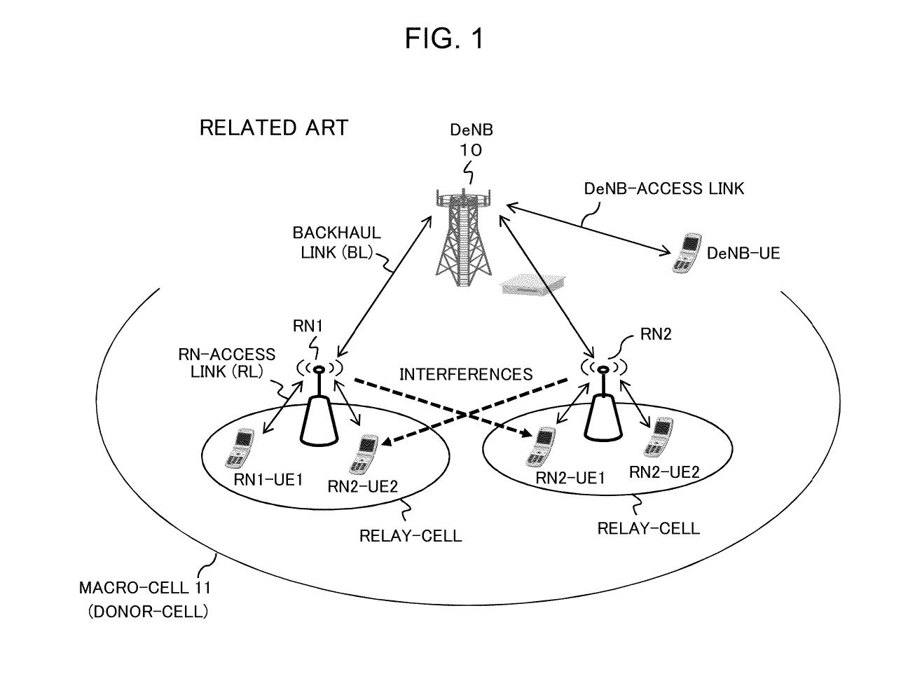

FIG. 2 is a schematic diagram for explaining the conventional RN-UE measurement of radio channel quality.

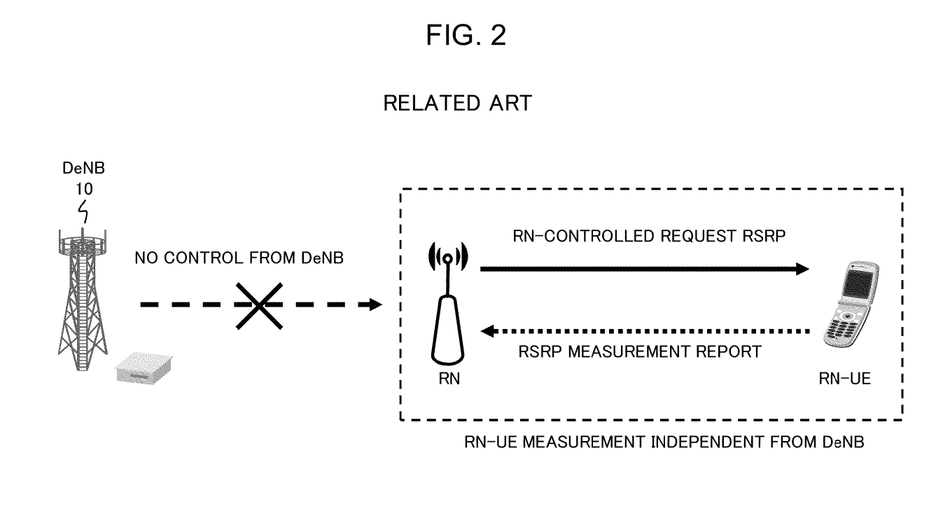

FIG. 3 is a schematic diagram showing a radio communication system which is used in common for illustrative embodiments of the present invention.

FIG. 4 is a block diagram of an illustrative configuration of a base station which is common for illustrative embodiments of the present invention.

FIG. 5 is a block diagram of an illustrative configuration of a relay node which is common for illustrative embodiments of the present invention.

FIG. 6 is a block diagram of an illustrative configuration of a mobile station (UE) which is common for illustrative embodiments of the present invention.

FIG. 7 is a sequence diagram showing the communication control method of the radio communication system according to a first illustrative embodiment.

FIG. 8 is a flow chart showing the communication control method of the base station (DeNB) according to the first illustrative embodiment.

FIG. 9 is a flow chart showing the communication control method of the relay node (RN) according to the first illustrative embodiment.

FIG. 10 is a schematic diagram showing an example of current backhaul subframe configurations.

FIG. 11 is a sequence diagram showing the communication control method of the radio communication system according to a second illustrative embodiment.

FIG. 12 is a flow chart showing the communication control method of the base station (DeNB) according to the second illustrative embodiment.

FIG. 13 is a flow chart showing the communication control method of the relay node (RN) according to the second illustrative embodiment.

FIG. 14 is a sequence diagram showing the communication control method of the radio communication system according to a third illustrative embodiment.

FIG. 15 is a flow chart showing the communication control method of the base station (DeNB) according to the third illustrative embodiment.

FIG. 16 is a flow chart showing the communication control method of the relay node (RN) according to the third illustrative embodiment.

FIG. 17 is a sequence diagram showing the communication control method of the radio communication system according to a fourth illustrative embodiment.

FIG. 18 is a schematic diagram showing an example of RSRP measurement subframe set at DeNB used in the radio communication system according to the fourth illustrative embodiment.

FIG. 19 is a flow chart showing the communication control method of the base station (DeNB) according to the fourth illustrative embodiment.

FIG. 20 is a flow chart showing the communication control method of the relay node (RN) according to the fourth illustrative embodiment.

### DETAILED DESCRIPTION

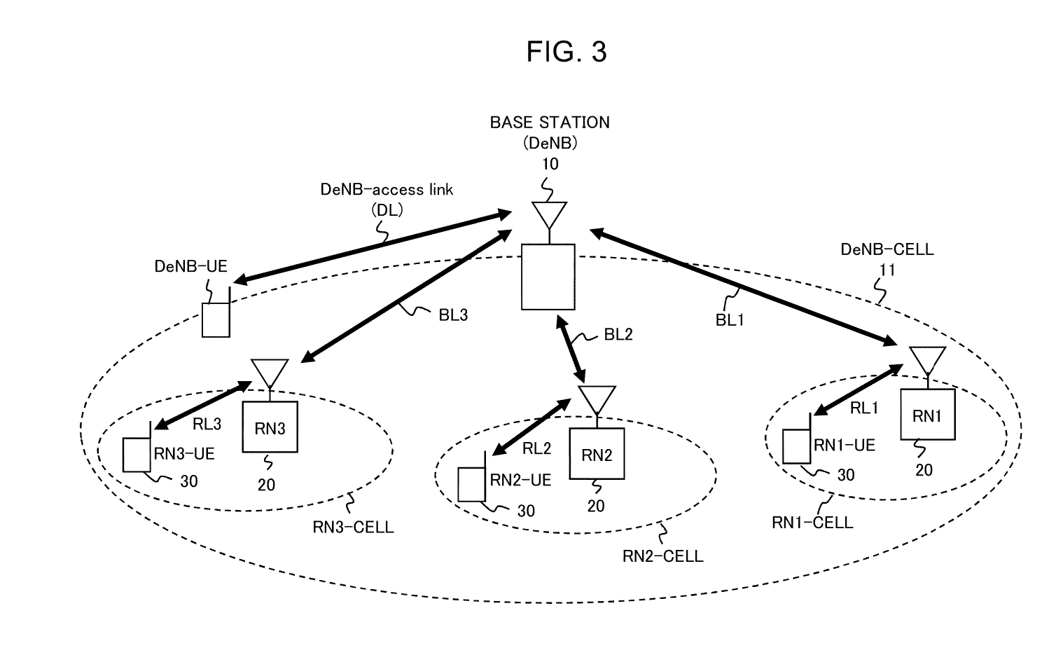

According to the present invention, a DeNB requests each RN to report interferences in the RN-access links from adjacent communication nodes that include at least adjacent RNs. Since the DeNB acquires information on the interference level between RN-access links, the DeNB can estimate and minimize interference level between RN-access links, allowing the optimum backhaul subframe coordination that maximizes the capacity of the RN. First, a radio communication system which is used in common for illustrative embodiments of the present invention will be explained by making references to FIGS. 3-6.

As shown in FIG. 3, It is assumed for simplicity that a radio communication system is comprised of a plurality of nodes which include a base station (DeNB) 10, relay nodes (RN1-RN3) 20, and user equipments (UEs) 30, wherein the DeNB 10 controls a macro cell or donor cell (DeNB-cell) 11 and RN1-RN3 control relay cells RN1-CELL, RN2-CELL and RN3-CELL, respectively. The DeNB 10 provides a radio connection to a user equipment DeNB-UE through a DeNB-access link DL and radio connections to the RN1-RN3 through backhaul links (or Un links) BL1-BL3, respectively. The RN1-RN3 also provide radio connections to the UEs 30 through RN-access links (or Uu links) RL1-RL3, respectively. Hereafter the UEs 30 are referred to as RN1-UE, RN2-UE and RN3-UE, respectively. Although FIG. 3 shows a single DeNB-UE and a single RN-UE for each RN-CELL, both DeNB 10 and each RN are capable of providing connections to multiple UEs simultaneously.

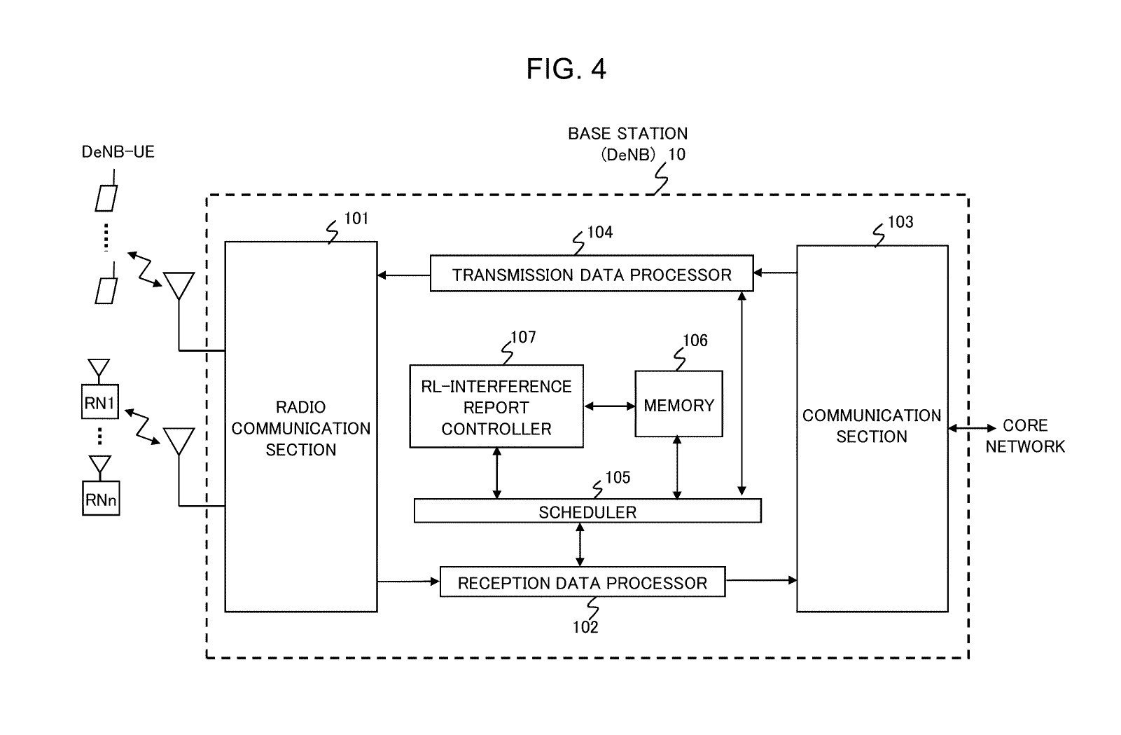

Referring to FIG. 4, the DeNB 10 is provided with a radio communication section 101 which performs radio communications with the DeNB-UE and the RNs through antennas. The radio communication section 101 receives uplink signals from the DeNB-UE and the RNs and outputs the uplink received signals to a reception data processor 102. The reception data processor 102 performs procedures including signal combining, demodulation, and channel decoding to retrieve data from the uplink received signals. The resulting received data are forwarded to a core network through a communication section 103.

A transmission data processor 104 stores data received from the communication section 103 in a buffer (not shown) before transmitting to the DeNB-UE and the RNs. The transmission data processor 104 performs channel encoding, rate matching, and interleaving on the data stored in the buffer in order to create transport channels. Then, the transmission data processor 104 adds control information to the transport channels and creates radio frames. The transmission data processor 104 also performs symbol mapping and creates transmission symbols. The radio communication section 101 modulates and amplifies transmission symbols to create downlink signals and then transmits the downlink signals to the DeNB-UE and the RNs through the antennas.

A scheduler 105 controls radio resource allocation for transmitting data to the DeNB-UE and the UEs 30 by considering scheduling metrics of the DeNB-UE and the RN1-RN3. The scheduling metrics are created by the scheduler 105 based on channel qualities of the DeNB-access link DL and the backhaul links BL1-BL3, and priorities of data to be transmitted to the DeNB-UE and the RN1-RN3.

A memory 106 stores Cell-IDs of RNs and backhaul subframe configurations of RNs and provides such information to the scheduler 105 when data are scheduled.

An RL-interference report controller 107 notifies and issues signaling for RN to report interference in the RN-access link (hereafter, referred to as RL-interference) and receives the report through the scheduler 105. When signaling is to be issued, the RL-interference report controller 107 is provided with the Cell-IDs of RNs and backhaul subframe configurations of RNs from the memory 106. The scheduler 105, when receiving the signaling for RN to report RL-interference from the RL-interference report controller 107, issues the signaling to the RN through the transmission data processor 104 and, when receiving RN's report of RL-interference through the reception data processor 102, forwards the report to the RL-interference report controller 107.

Functions of the reception data processor 102, the transmission data processor 104, the scheduler 105 and the RL-interference report controller 107 can be implemented by a program-controlled processor such as a CPU (central processing unit) or a computer running respective programs which are stored in a memory (not shown).

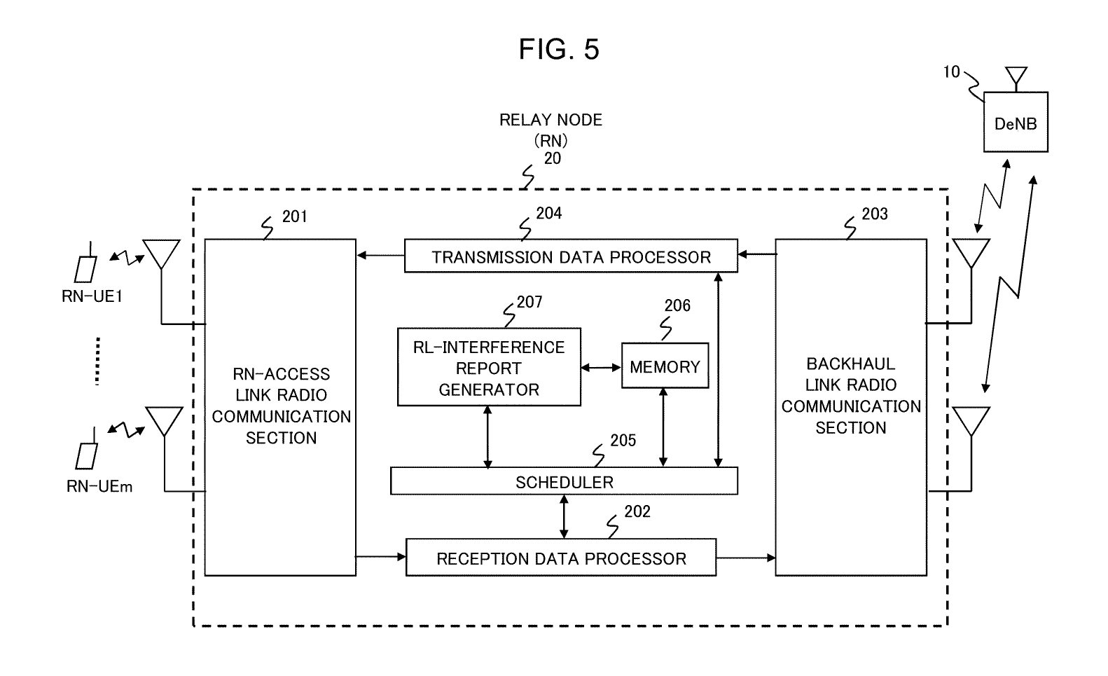

Referring to FIG. 5, it is assumed that RN 20 has the same functionalities as the DeNB 10 with some exceptions that will be explained explicitly. A RN-access link radio communication section 201 receives uplink signals from RN-UEs through antennas. A reception data processor 202, similar to the reception data processor 102 of the DeNB 10, forwards the received data to the DeNB 10 through a backhaul link radio communication section 203. A transmission data processor 204 and its buffer (not shown), similar to the transmission data processor 204 and its buffer of the DeNB 10, creates transmitted symbols based on data destined to the RN-UEs received from the backhaul link radio communication section 203. Then, the RN-access link radio communication section 201 creates downlink signals from the transmitted symbols and transmits them to the RN-UEs.

A scheduler 205 controls radio resource allocation for transmitting data to the RN-UEs by considering scheduling metrics of RN-UEs. The scheduling metrics are created by the scheduler 205 based on channel qualities of the RN-access links RLs, and priorities of data to be transmitted to the RN-UEs.

A memory 206 stores backhaul subframe configuration of RN and information included in signaling from the DeNB 10 and provides such information to the scheduler 205 when data are scheduled.

An RL-interference report generator 207, when receiving signaling from the DeNB 10 through the scheduler 205, requests and receives RSRP measurement from RN-UEs through the scheduler 205 and then creates and sends RL-interference report to the DeNB 10 through the scheduler 205. When RSRP measurement request and/or report are created, the RL-interference report generator 207 is provided with the backhaul subframe configuration of RN and information included in the signaling from the memory 206. The scheduler 205, when receiving signaling for RN to report interference from the transmission data processor 204, forwards signaling to the RL-interference report generator 207; when receiving RSRP measurement request from the RL-interference report generator 207, sends request to RN-UE through the transmission data processor 204; when receiving RSRP measurement results by RN-UE from the reception data processor 202, forwards results to the RL-interference report generator 207; and when receiving RL-interference report from the RL-interference report generator 207, sends the report to the DeNB 10 through the reception data processor 202.

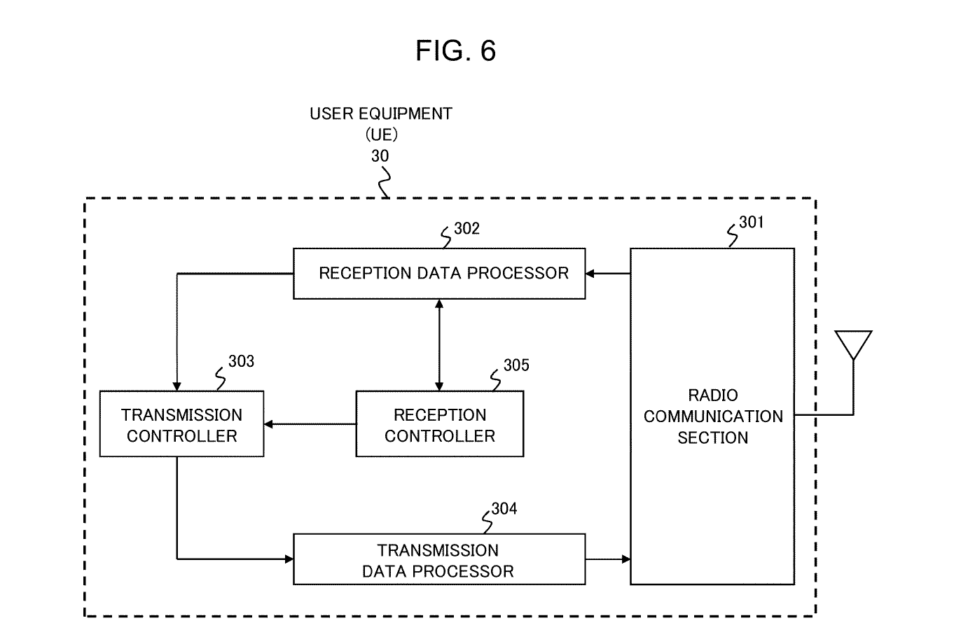

Referring to FIG. 6, UE 30 includes a radio communication section 301, reception data processor 302, a transmission controller 303, transmission data processor 304 and reception controller 305. The radio communication section 301 receives radio signals from the DeNB 10 or RN 20 through an antenna. The reception data processor 302 performs a process for retrieving data from the received downlink signals and notifies the transmission controller 303, which controls the transmission operation of the UE 30, of the reception processing result. The transmission controller 303 then transmits the reception processing result to the DeNB 10 or RN 20 through the transmission data processor 304 and the radio communication section 301. On the other hand, when data to be transmitted are generated, the transmission data processor 304 outputs the transmission data under the control of the transmission controller 303 to the communication section 301. The radio communication section 301 creates uplink signals from the transmission data received from the transmission data processor 304, and transmits them to the DeNB 10 or RN 20.

The reception data processor 302, when receiving a RSRP measurement request from the RN to which the UE 30 is connected through the RN-access link, forwards a request to the reception controller 305. When receiving the RSRP measurement request from the RN, the reception controller 305 issues a measurement command to the reception data processor 302. When receiving the measurement command from the reception controller 305, the reception data processor 302 measures RSRP and forward its result to the transmission controller 303, which controls the transmission data processor 304 to transmit the RSRP measurement result to the RN.

### 1. First Illustrative Embodiment

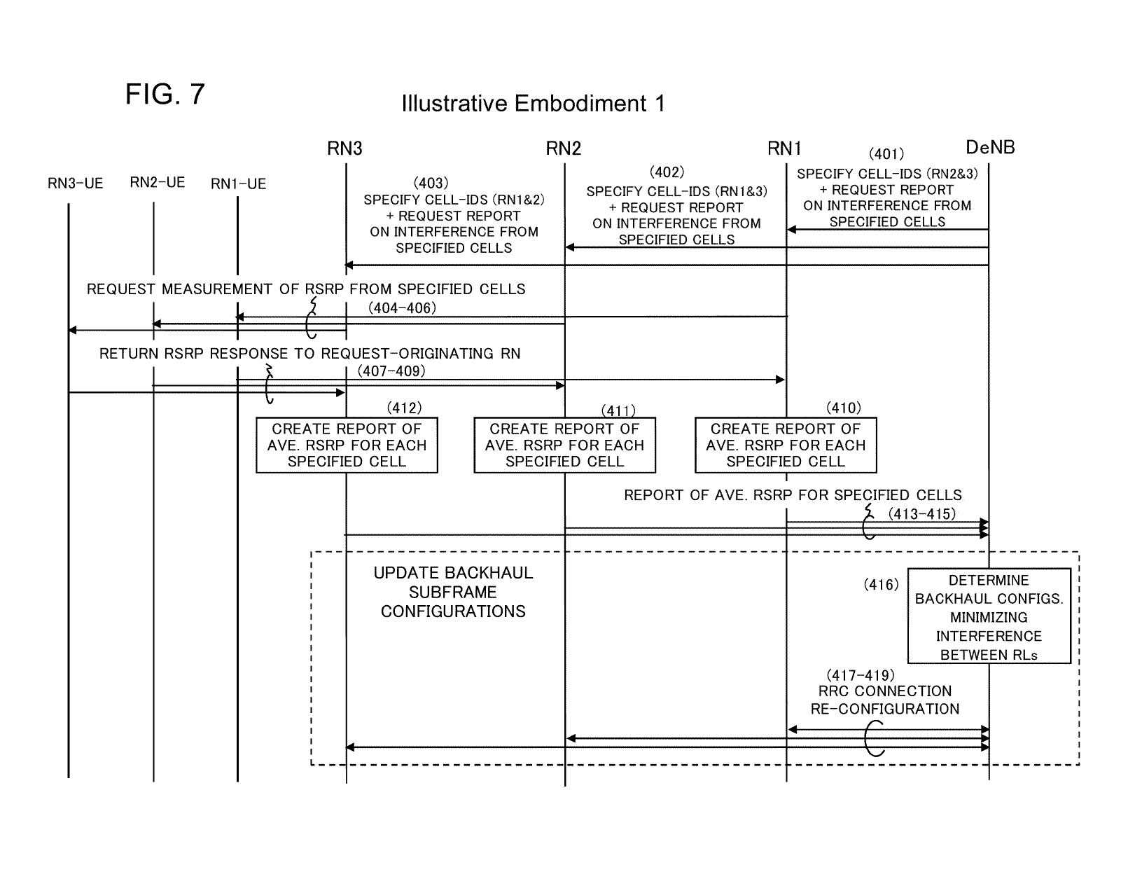

According to the first illustrative embodiment, a DeNB signals each of its RNs to report RL-interferences from adjacent communication nodes that include at least adjacent RNs. The DeNB specifies for each RN Cell-IDs based on a record of Cell-IDs of RNs, and request each RN to report RL-interferences from nodes with the specified Cell-IDs. Each RN acquires from RN-UEs interferences from nodes with the specified Cell-IDs, and creates a report based on a statistical property of the acquired interferences and sends the report to the DeNB. The DeNB updates backhaul subframe configurations applied at RNs based on the received report. Taking as an example the network shown in FIG. 3, a control operation of the above-mention system according to the first illustrative embodiment will be explained by making references to FIGS. 7-9.

### 1.1) System Operation

Referring to FIG. 7, the DeNB 10 requests a report on RL-interferences from specified adjacent cells for each RN connected to the DeNB 10 by backhaul link. More specifically, the DeNB 10 sends cell-IDs (RN2 and RN3) and a report request with the specified cell-IDs to the RN1 (operation 401). Similarly, the DeNB 10 sends cell-IDs (RN1 and RN3) and a report request with the specified cell-IDs to the RN 2 (operation 402) and sends cell-IDs (RN1 and RN2) and a report request with the specified cell-IDs to the RN 3 (operation 403). The report request includes the following parameters: Reporting criteria; Measurement type; and Measurement object. Reporting criteria is Periodic or Event-triggered. Measurement type is RSRP or RSRQ. Measurement object is Any cell-ID that RN-UE can detect or Specific Cell-ID. In this example, when receiving the request from the DeNB 10, each of the RN1-RN3 sends to RN-UEs connected to the RN by RN-access link a request for measurement of RSRP from nodes with the specified cells (operations 404-406).

Each of the RN1-UE, RN2-UE and RN3-UE measures RSRP from each of the nodes with the specified cells based on the RSRP measurement request received from the RN and sends the measured RSRP back to the RN originating the RSRP-measurement request (operations 407-409).

Each of the RN1-RN3, when receiving the measured RSRP from the RN-UEs, calculates average RSRP and creates a report of average RSRP (operations 410-412). The calculation of average RSRP will be described in detail later. The report of average RSRP for each of the specified cells is sent from each RN to the DeNB 10 (operations 413-415).

The DeNB 10 uses the average RSRP received from the RN1-RN3 to determine the backhaul configurations which minimizes interference between RN-access links (operation 416) and performs RRC connection re-configuration to apply the determined backhaul subframe configurations (operations 417-419). The update of backhaul subframe configurations will be described in detail later.

### 1.2) DeNB Operation

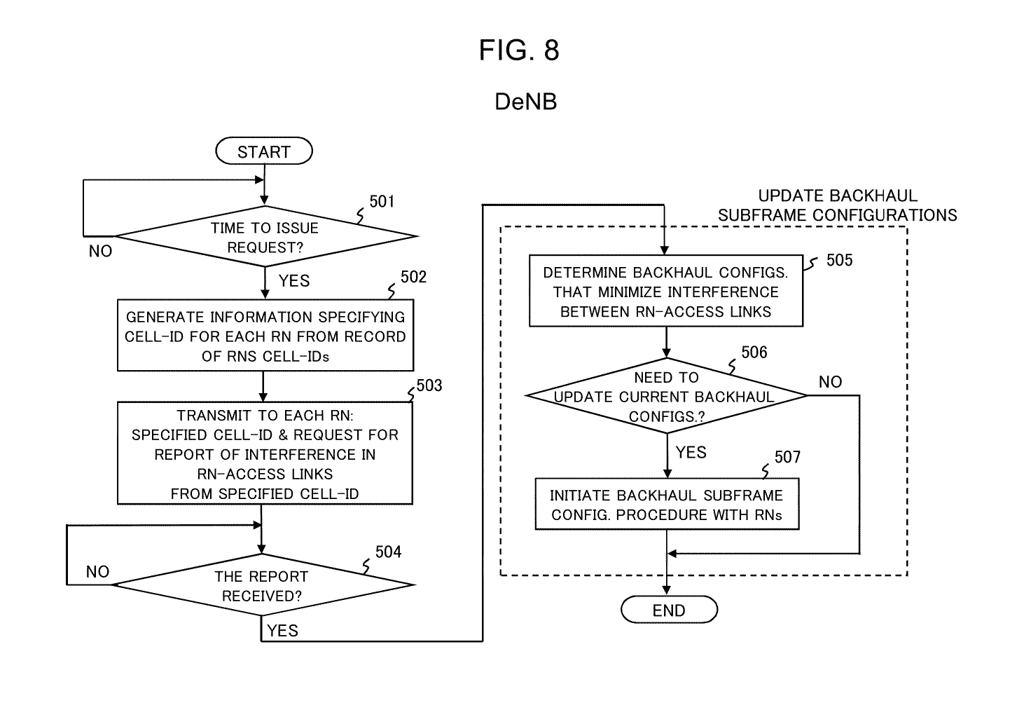

Referring to FIG. 8, the scheduler 105 checks whether it is time to issue a request for report on interference (operation 501). Time to issue the request can be controlled by operator. Alternatively, the request can be issued periodically, when the number of RNs and/or RN-UEs exceeds a predefined value. When it is time to issue a request for report on interference (operation 501; YES), the RL-interference report controller 107 inputs the Cell-IDs of RNs and backhaul subframe configurations of RNs from the memory 106 and generates information specifying cell-IDs for each RN (operation 502). The scheduler 105, when receiving the information specifying cell-IDs for each RN, transmits to each RN the specified cell-IDs and the request for report of interference in RN-access links from specified cells through the transmission data processor 104 and the radio communication section 101 (operation 503). Thereafter the scheduler 105 enters a state of waiting for a report of interference (operation 504; NO).

When receiving the reports from the RNs through the radio communication section 101 and the reception data processor 102 (operation 504; YES), the scheduler 105 outputs the report to the RL-interference report controller 107.

Based on RL-interference information included in the reports, the RL-interference report controller 107 determines the backhaul configurations which minimize interference between RN-access links (operation 505). If there is a need to update current backhaul configurations (operation 506; YES), the RL-interference report controller 107 uses the determined backhaul subframe configurations to initiate the backhaul subframe configuration procedure with the RNs (operation 507).

### 1.3) RN Operation

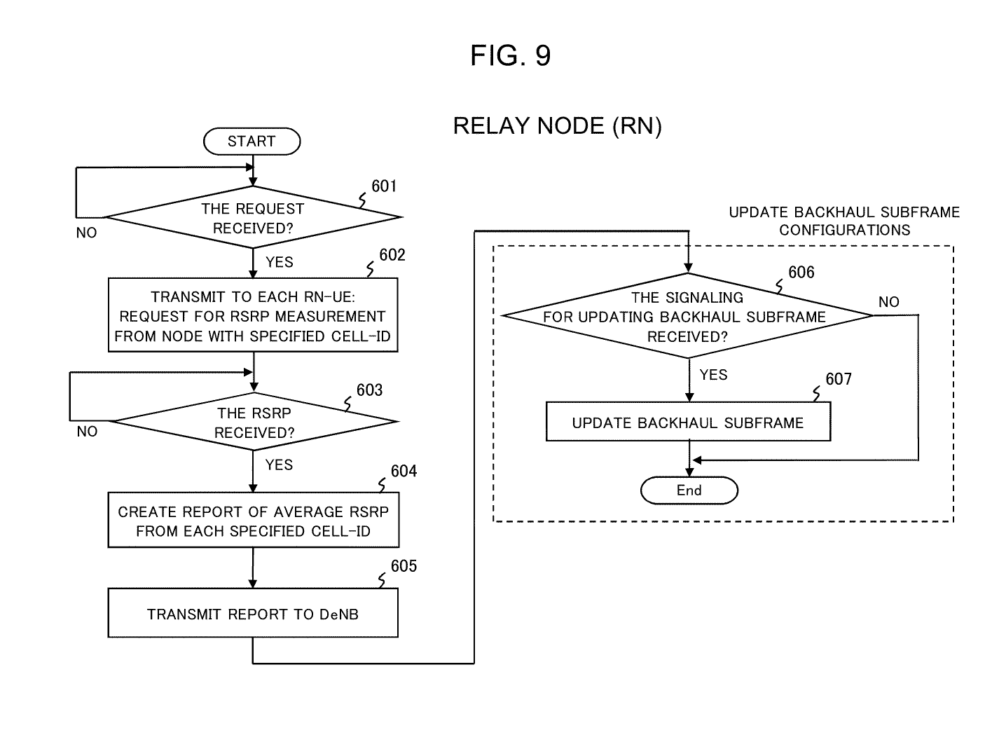

Referring to FIG. 9, when receiving the request from the DeNB 10 through the backhaul link radio communication section 203, the transmission data processor 204 and the scheduler 205 (operation 601; YES), the RL-interference report generator 207 sends to RN-UEs a request for measurement of RSRP from nodes with the specified cells through the scheduler 205, the transmission data processor 204 and the RN-access link radio communication section 201 (operation 602).

When receiving the measured RSRPs from the respective RN-UEs (operation 603; YES), the RL-interference report generator 207 calculates average RSRP for each specified cell-ID and creates a report of the calculation results (operation 604). And the report is sent to the DeNB 10 (operation 605).

When receiving the signaling for updating backhaul subframe from the DeNB 10 (operation 606; YES), the scheduler 205 updates backhaul subframes according to information included in the signaling (operation 607).

### 1.4) Example

Average RSRP from the specified Cell-ID “a” with respect to the number of RN-UEs connecting to the RN with Cell-ID “b”, avgRSRP_{a->b} is calculated by the following expression:

$${avgRSRP}_{a \to b} = {\sum }_{k}^{K} {RSRP}_{a \to b} ( k ) / K \qquad [ Math . 1 ]$$

where a=Cell-ID of interfering RN, b=Cell-ID of serving RN, K=Total number of RN-UEs at RN with Cell-ID “b”, k=Index of RN-UEs (k=1, . . . ,K), and RSRP_{a->b}(k)=RSRP from RN with Cell-ID “a” measured by k-th RN-UE of RN with Cell-ID “b”.

The backhaul subframe configurations can be determined by Initialization and Optimization as follows:

Initialization

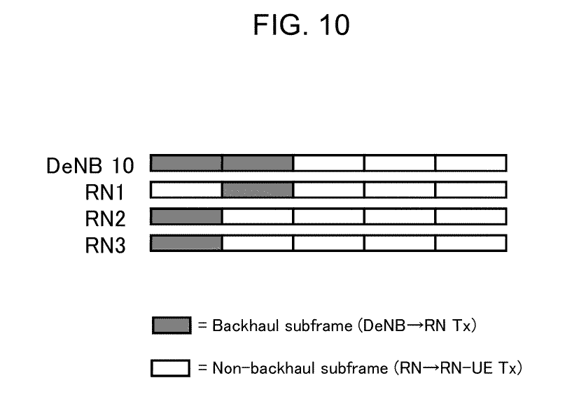

Assuming current backhaul subframe configurations as shown in FIG. 10, system constraint derived from current backhaul subframe configurations is as follows:

Number of backhaul subframes at DeNB=2, and

Number of backhaul subframe for each RN=1.

Current interference between RN-access links, I₀, in backhaul subframes at DeNB is expressed as follows:

I₀=avgRSRP_{2->3}+avgRSRP_{3->2}.

Optimization

Optimization is performed by the following algorithm:

Step 1. Set b=1, where b=Index of RN

Step 2. Vary backhaul subframe configuration of the b-th RN while fixing the others, subjected to the system constraint

Step 3. Evaluate interference between RN-access links (I_{update}) with respect to the variation in the backhaul subframe configuration of the b-th RN

Step 4. If I_{update}<I₀, replace the current backhaul subframe configuration with the variation.

Otherwise, keep the current backhaul subframe configuration

Step 5. Repeat 2. to 4. until all variations of backhaul subframe configuration of the b-th RN are evaluated

Step 6. Update b=b+1 and repeat 2. to 6. until all RNs are evaluated.

Variations of backhaul subframe configurations are as follows:

### Variation 1:

I_{update}=avgRSRP_{1->2}+avgRSRP_{2->1}

### Variation 2:

I_{update}=avgRSRP_{1->3}+avgRSRP_{3->1}

### 1.5) Advantageous Effect

As described above, according to the first illustrative embodiment, the DeNB 10 requests each RN to report RL-interferences from adjacent communication nodes that include at least adjacent RNs, thereby acquiring information on the interference level between RN-access links. Since the DeNB can know interference level between RN-access links, the DeNB 10 minimizes interference level between RN-access links, allowing the optimum backhaul subframe coordination that maximizes the capacity of the RN.

### 1.6) Variations

The RN may send to the DeNB 10 a report which is not based on statistical property of acquired RSRP. In other words, acquired RSRP are sent to the DeNB 10 in their original forms.
The RN may send to the DeNB 10 a report which is based on statistical property of acquired RSRP.
Weighted average RSRP with respect to number of RN-UEs,
weight=normalized number of RN-UEs in each RN with predefined constant.
50%-tile RSRP value with respect to RSRP values reported by all RN-UEs.
5%-tile RSRP value with respect to RSRP values reported by all RN-UEs.
Trigger of RN acquiring RSRP may be independent from DeNB's signaling.
RN can independently acquire from RN-UEs RSRP from adjacent nodes and store the RSRP. When receiving the request from the DeNB 10, RN creates a report based on the stored RSRP and the specified Cell-IDs and sends the report to the DeNB 10.

### 2. Second Illustrative Embodiment

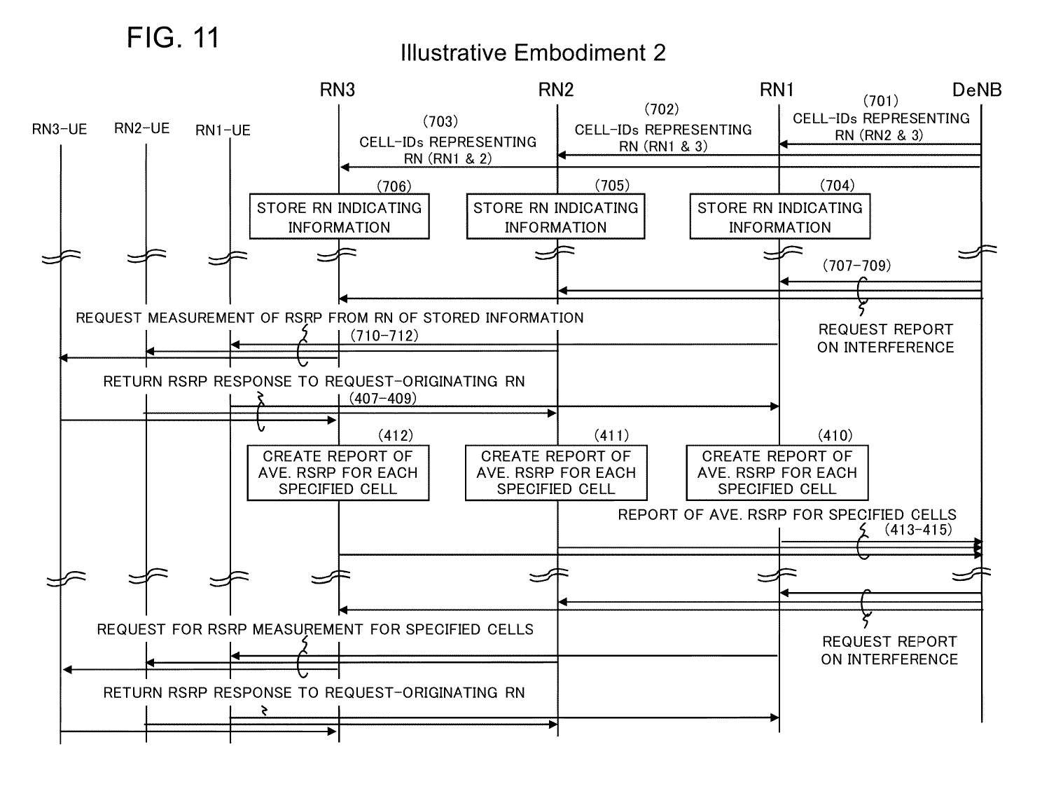

According to the second illustrative embodiment, a DeNB notifies each RN for storing information for identifying which nodes are RNs, and separately requests each RN to report interferences in RN-access links (RL-interferences) from RNs, and each RN acquires from RN-UEs RSRP from RNs in the stored information, and creates and sends a report to the DeNB based on a statistical property of the acquired RSRP. The DeNB updates backhaul subframe configurations applied at RNs based on the received report. Taking as an example the network shown in FIG. 3, a control operation of the above-mention system according to the second illustrative embodiment will be explained by making references to FIGS. 11-13.

### 2.1) System Operation

Referring to FIG. 11, first, the DeNB 10 sends RN indicating information (cell-IDs representing RN) to each RN. More specifically, the DeNB 10 sends cell-IDs of RN1 and RN3 to the RN2 (operation 702) and cell-IDs of RN1 and RN2 to the RN3 (operation 703). When receiving these cell-IDs from the DeNB 10, the RN1, RN2 and RN3 store respective RN indicating information (operations 704-706).

After the RN indicating information has been stored in each RN, the DeNB 10 sends the report request to each RN (operations 707-709). In this example, when receiving the request from the DeNB 10, each of the RN1-RN3 sends to RN-UEs connected to the RN by RN-access link a request for measurement of RSRP from nodes specified by the RN indicating information (operations 710-712). The operations 407-415 and the operation of updating backhaul subframe configurations following the request operations 710-712 are similar to those described in FIG. 7 and therefore detailed descriptions will be omitted.

### 2.2) DeNB Operation

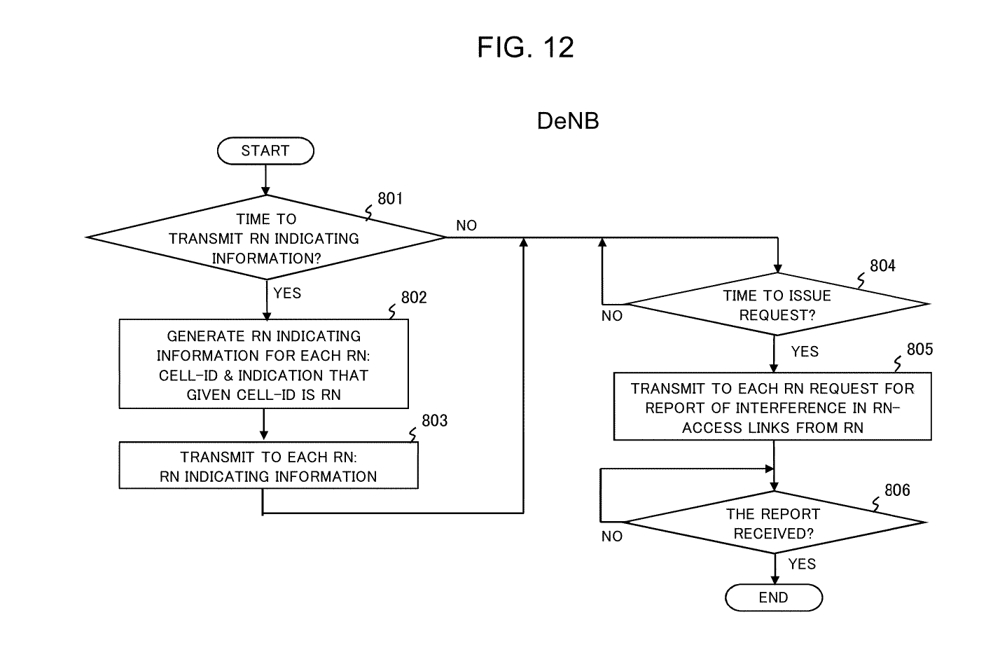

Referring to FIG. 12, the scheduler 105 checks whether it is time to transmit RN indicating information (operation 801). Time to transmit RN indicating information can be when there is a change in the number of RNs. When it is time to transmit RN indicating information (operation 801; YES), the RL-interference report controller 107 inputs the Cell-IDs of RNs and backhaul subframe configurations of RNs from the memory 106 and generates RN indicating information for each RN (operation 802). The scheduler 105, when receiving the RN indicating information for each RN, transmits to each RN the RN indicating information (operation 803). After the operation 803 or when it is not the time to transmit RN indicating information (operation 801; NO), the RL-interference report controller 107 enters a state of waiting until the time to issue a request for interference in RN-access links (operation 804).

The scheduler 105 checks whether it is time to issue a request for report on interference (operation 804). Time to issue a request for report on interference can be controlled by operator. Alternatively, the request can be issued periodically or when the number of RN-UEs exceeds a predefined value. When it is time to issue a request for report on interference (operation 804; YES), the RL-interference report controller 107 generates the request for report of interference in RN-access links from RN according to the stored RN indicating information (operation 805). Thereafter the scheduler 105 enters a state of waiting for a report of interference (operation 806). When receiving the report from each RN (operation 806; YES), the RL-interference report controller 107 determines the backhaul configurations minimizing interference between RN-access links, which has been already described in the first illustrative embodiment.

### 2.3) RN Operation

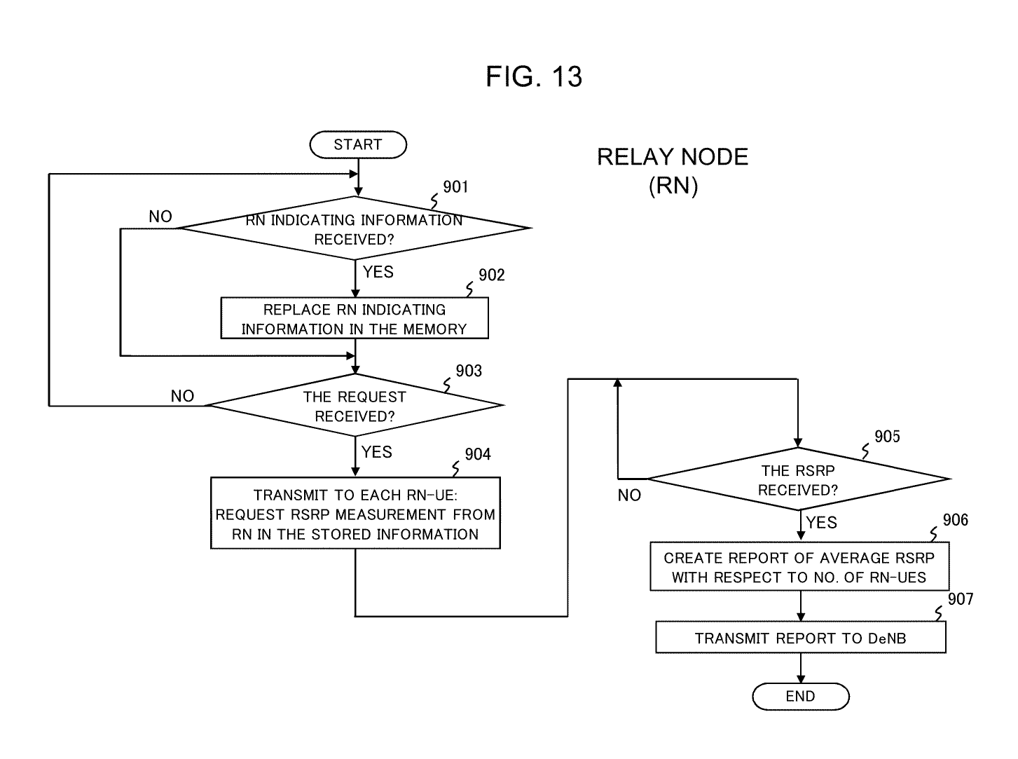

Referring to FIG. 13, when receiving the RN indicating information from the DeNB 10 (operation 901; YES), the RL-interference report generator 207 stores the RN indicating information in the memory 206 (operation 902). When the RN indicating information has been stored or when the RN indicating information has not been received (operation 901; NO), the RL-interference report generator 207 checks whether the request for report is received from the DeNB 10 (operation 903). If not (operation 903; NO), the control goes back to the operation 901.

When receiving the request from the DeNB 10 (operation 903; YES), the RL-interference report generator 207 sends to RN-UEs a request for measurement of RSRP from RNs according to the stored RN indicating information (operation 904).

When receiving the measured RSRPs from the respective RN-UEs (operation 905; YES), the RL-interference report generator 207 calculates average RSRP for each RN indicated by the stored RN indicating information and creates a report of the calculation results (operation 906). And the report is sent to the DeNB 10 (operation 907).

### 2.4) Advantageous Effect

As described above, according to the second illustrative embodiment, the DeNB can know interference level between RN-access links as in the first illustrative embodiment. Therefore the DeNB 10 can minimize interference level between RN-access links, allowing the optimum backhaul subframe coordination that maximizes the capacity of the RN.

In addition, the DeNB notifies each RN of information for identifying which nodes are RNs, and thereafter separately requests each RN to report interferences in RN-access links from RNs. Accordingly, compared to the first illustrative embodiment, less amount of information is needed for DeNB to signal RN to report interference when more than one requests are issued over time, causing the DeNB to reduce RN signaling overhead.

### 2.5) Variations

The RN may send to the DeNB 10 a report which is not based on statistical property of acquired RSRP. In other words, acquired RSRP are sent to the DeNB 10 in their original forms.
The RN may send to the DeNB 10 a report which is based on statistical property of acquired RSRP.
Weighted average RSRP with respect to number of RN-UEs,
   weight=normalized number of RN-UEs in each RN with predefined constant.
50%-tile RSRP value with respect to RSRP values reported by all RN-UEs.
5%-tile RSRP value with respect to RSRP values reported by all RN-UEs.
Trigger of RN acquiring RSRP may be independent from DeNB's signaling.
RN can independently acquire from RN-UEs RSRP from RNs indicated by the stored RN indicating information and store the RSRP. When receiving the request from the DeNB 10, RN creates a report based on the stored RSRP and sends the report to the DeNB 10.

### 3. Third Illustrative Embodiment

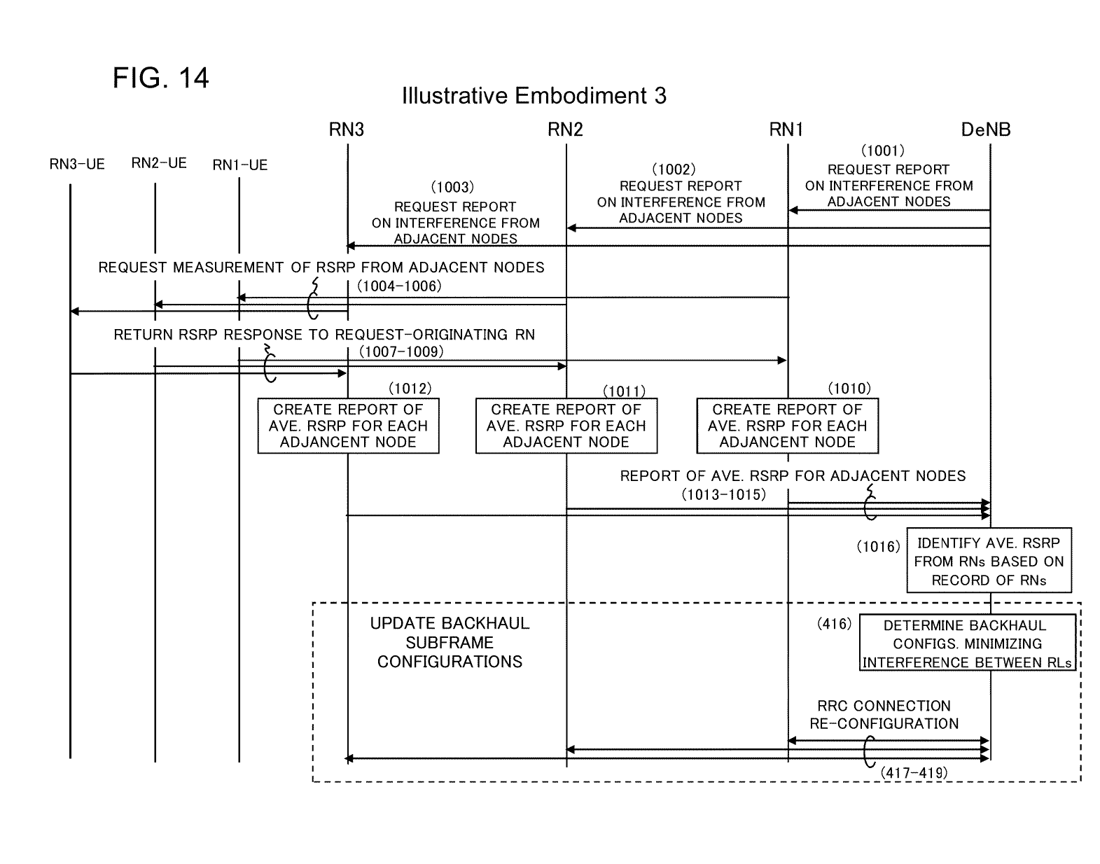

According to the third illustrative embodiment, a DeNB requests each RN to report interferences in RN-access links (RL-interferences) from adjacent nodes. Each RN acquires from RN-UEs RSRP received from the adjacent nodes, and creates and sends a report to the DeNB based on a statistical property of the acquired RSRP. The DeNB identifies interferences from RNs based on a record of RN Cell-IDs. The DeNB updates backhaul subframe configurations applied at RNs based on the received report. Taking as an example the network shown in FIG. 3, a control operation of the above-mention system according to the third illustrative embodiment will be explained by making references to FIGS. 14-16.

### 3.1) System Operation

Referring to FIG. 14, the DeNB 10 requests a report on interferences from adjacent cells for each RN connected to the DeNB 10 by backhaul link. More specifically, the DeNB 10 sends the report request to the RN1, RN2 and RN3 (operations 1001-1003). In this example, when receiving the request from the DeNB 10, each of the RN1-RN3 sends to RN-UEs connected to the RN by RN-access link a request for measurement of RSRP from adjacent nodes (operations 1004-1006).

Each of the RN1-UE, RN2-UE and RN3-UE measures RSRP from each of adjacent nodes and sends the measured RSRP and cell-IDs of interfering nodes back to the RN originating the RSRP-measurement request (operations 1007-1009).

Each of the RN1-RN3, when receiving the measured RSRPs from the respective RN-UEs, calculates average RSRP as described above and creates a report of the average RSRP and the cell-IDs of interfering nodes (operations 1010-1012). The report is sent from each RN to the DeNB 10 (operations 1013-1015).

The DeNB 10 searches the record of cell-IDs of RNs for cell-IDs indicating RNs among the cell-IDs of interfering nodes received from the RN1-RN3, to identify average RSRP from nodes with cell-IDs of interfering RNs (operation 1016). The DeNB 10 uses the identified average RSRP from the interfering RNs to determine the backhaul configurations which minimizes interference between RN-access links and performs RRC connection re-configuration by applying the determined backhaul subframe configurations (operations 417-419).

### 3.2) DeNB Operation

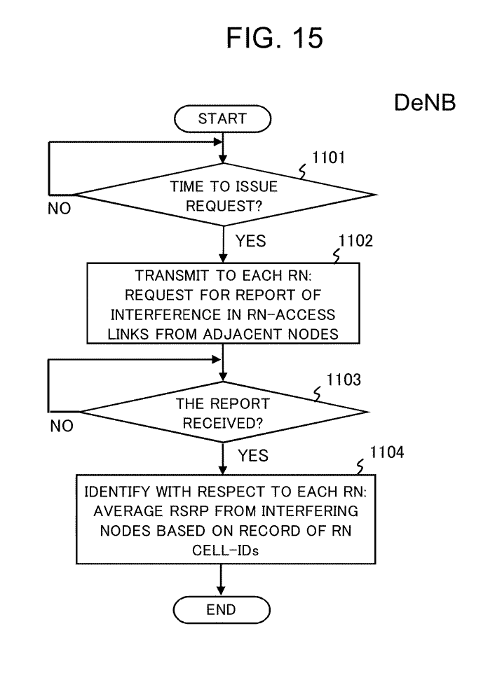

Referring to FIG. 15, the scheduler 105 checks whether it is time to issue a request for report on interference (operation 1101). Time to issue the request can be controlled by operator. Alternatively, the request can be issued periodically, when the number of RNs and/or RN-UEs exceeds a predefined value. When it is time to issue a request for report on interference (operation 1101; YES), the RL-interference report controller 107 transmits to each RN the request for report of RL-interferences from adjacent nodes (operation 1102). Thereafter the scheduler 105 enters a state of waiting for a report of interference (operation 1103; NO).

When receiving the report from each RN (operation 1103; YES), the RL-interference report controller 107 searches the memory 106 for cell-IDs indicating RNs among the cell-IDs of interfering nodes received from the RN1-RN3, to identify average RSRP for each interfering RN (operation 1104). The RL-interference report controller 107 determines the backhaul configurations minimizing interference between RN-access links, which has been already described in the first illustrative embodiment.

### 3.3) RN Operation

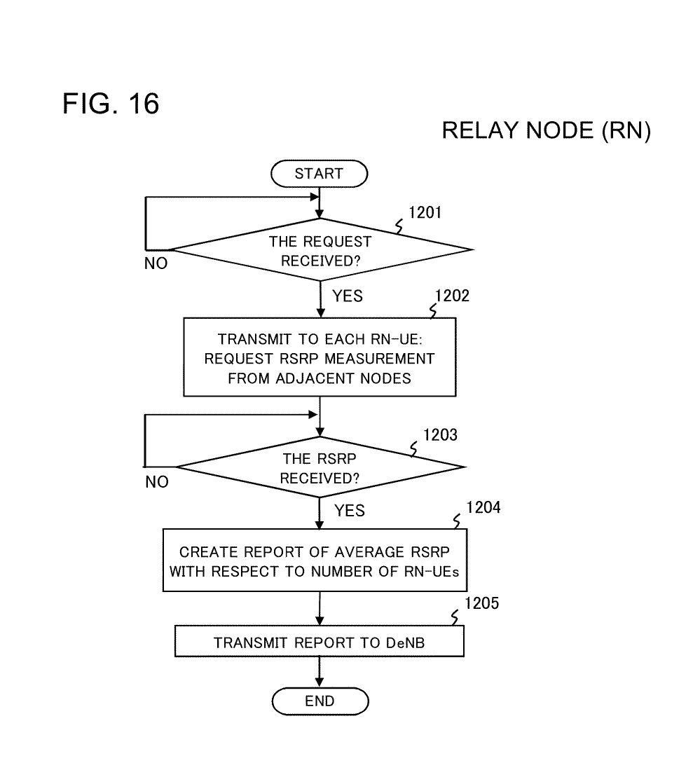

Referring to FIG. 16, when receiving the request from the DeNB 10 (operation 1201; YES), the RL-interference report generator 207 sends to each RN-UE a request for measurement of RSRP from adjacent nodes (operation 1202).

When receiving the measured RSRPs from the respective RN-UEs (operation 1203; YES), the RL-interference report generator 207 calculates average RSRP with respect to the number of RN-UEs for each interfering node to create a report of the calculation results (operation 1204) and sends the report to the DeNB 10 (operation 1205).

### 3.4) Advantageous Effect

As described above, according to the third illustrative embodiment, the DeNB can know interference level between RN-access links as in the first illustrative embodiment. Therefore the DeNB 10 can minimize interference level between RN-access links, allowing the optimum backhaul subframe coordination that maximizes the capacity of the RN.

In addition, the DeNB requests each RN to report interference in RN-access links from adjacent nodes. Each RN acquires from RN-UEs RSRP from the adjacent nodes, and creates and sends a report to the DeNB based on a statistical property of the acquired RSRP. The DeNB identifies interferences from RNs based on a record of RN Cell-IDs. Accordingly, compared to the second illustrative embodiment, even less amount of information is needed for DeNB to signal RN to report interference, causing the DeNB to furthermore reduce RN signaling overhead.

### 3.5) Variations

The RN may send to the DeNB 10 a report which is not based on statistical property of acquired RSRP. In other words, acquired RSRP are sent to the DeNB 10 in their original forms.
The RN may send to the DeNB 10 a report which is based on statistical property of acquired RSRP.
Weighted average RSRP with respect to number of RN-UEs,
   weight=normalized number of RN-UEs in each RN with predefined constant.
50%-tile RSRP value with respect to RSRP values reported by all RN-UEs.
5%-tile RSRP value with respect to RSRP values reported by all RN-UEs.
Trigger of RN acquiring RSRP may be independent from DeNB's signaling.
RN can independently acquire from RN-UEs RSRP from adjacent nodes and store the RSRP. When receiving the request from the DeNB 10, RN creates a report based on the stored RSRP and sends the report to the DeNB 10.

### 4. Fourth Illustrative Embodiment

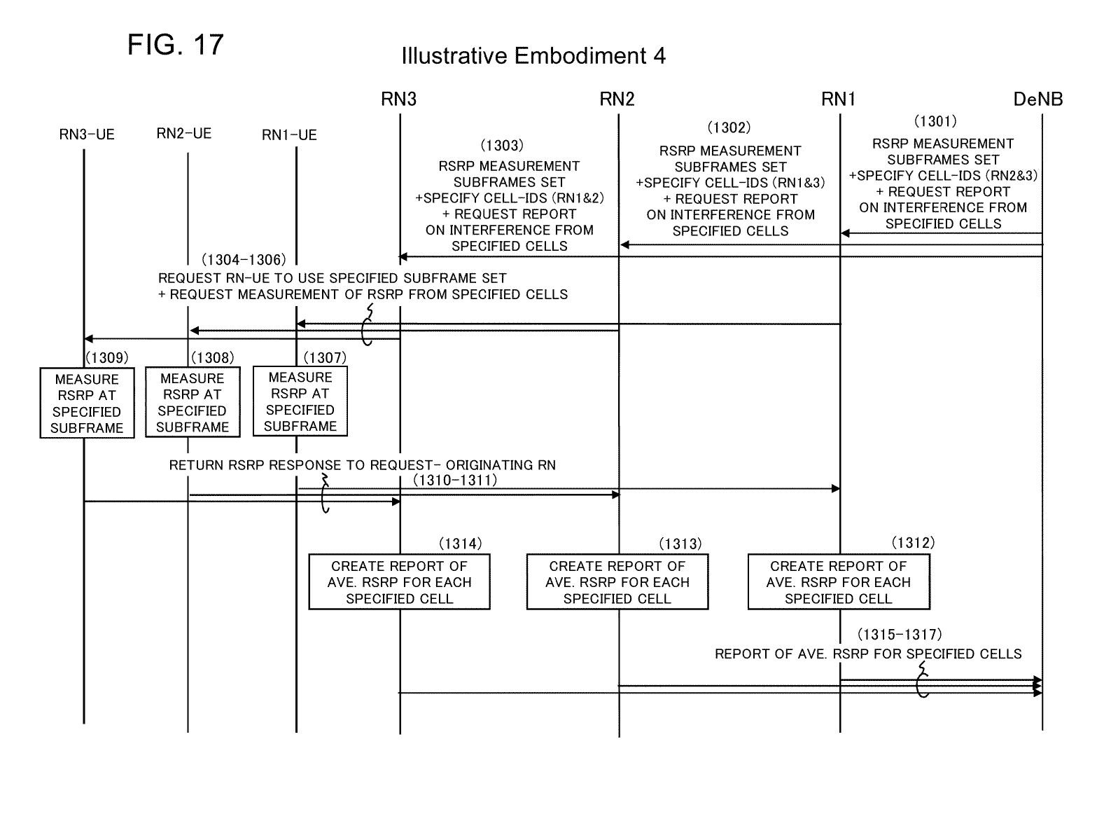

According to the fourth illustrative embodiment, a DeNB specifies for each RN a set of subframes for RN-UEs to measure RSRP based on a record of backhaul subframe configurations of RNs, also specifies Cell-IDs based on a record of RN Cell-IDs, and request each RN to report interferences in RN-access links (RL-interferences) from nodes with the specified Cell-IDs. Each RN requests RN-UEs to use the specified set of subframes for RSRP measurement, acquires from RN-UEs RSRPs from respective nodes with the specified Cell-IDs, and creates and sends a report to the DeNB based on a statistical property of the acquired RSRP. The DeNB updates backhaul subframe configurations applied at RNs based on the received reports. Taking as an example the network shown in FIG. 3, a control operation of the above-mention system according to the fourth illustrative embodiment will be explained by making references to FIGS. 17-20.

### 4.1) System Operation

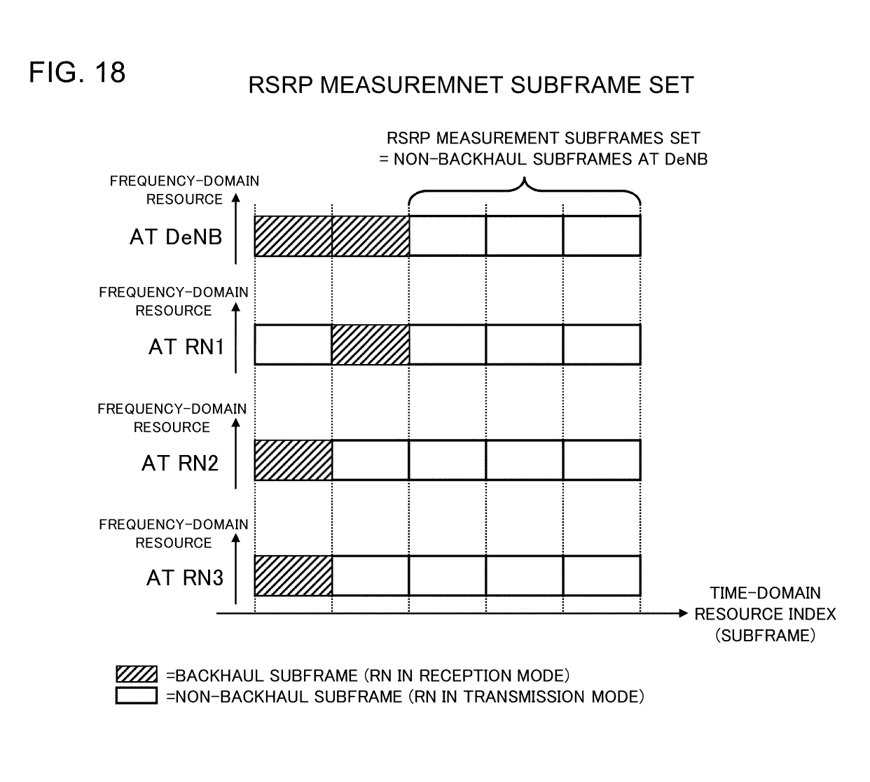

Referring to FIG. 17, the DeNB 10 notifies each RN of RSRP measurement subframe set for RN-UEs to measure RSRP based on a record of backhaul subframe configurations of RNs, specifies Cell-IDs of adjacent RNs, and requests a report on interferences from specified adjacent cells. An example of the RSRP measurement subframe set is shown in FIG. 18, which is a set of non-backhaul subframes at DeNB.

More specifically, the DeNB 10 sends the RSRP measurement subframe set, the specified cell-IDs (RN2 and RN3) and a report request with the specified cell-IDs to the RN1 (operation 1301). Similarly, the DeNB 10 sends the RSRP measurement subframe set, the specified cell-IDs (RN1 and RN3) and a report request with the specified cell-IDs to the RN 2 (operation 1302) and sends the RSRP measurement subframe set, cell-IDs (RN1 and RN2) and a report request with the specified cell-IDs to the RN 3 (operation 1303). In this example, when receiving the request from the DeNB 10, each of the RN1-RN3 sends to RN-UEs connected to the RN by RN-access link a request for RN-UE to use the specified subframe set and measurement of RSRP from nodes with the specified cells (operations 1304-1306).

Each of the RN1-UE, RN2-UE and RN3-UE measures RSRP from each of the nodes with the specified cells at the specified subframe set (operations 1307-1309) and sends the measured RSRP back to the RN originating the RSRP-measurement request (operations 1310-1311).

Each of the RN1-RN3, when receiving the measured RSRP from the RN-UEs, calculates average RSRP for each specified cell and creates a report of average RSRP (operations 1312-1314). The report of average RSRP for each of the specified cells is sent from each RN to the DeNB 10 (operations 1315-1317).

The DeNB 10 uses the average RSRP received from the RN1-RN3 to determine the backhaul configurations which minimizes interference between RN-access links and performs RRC connection re-configuration by applying the determined backhaul subframe configurations as in the first illustrative embodiment.

### 4.2) DeNB Operation

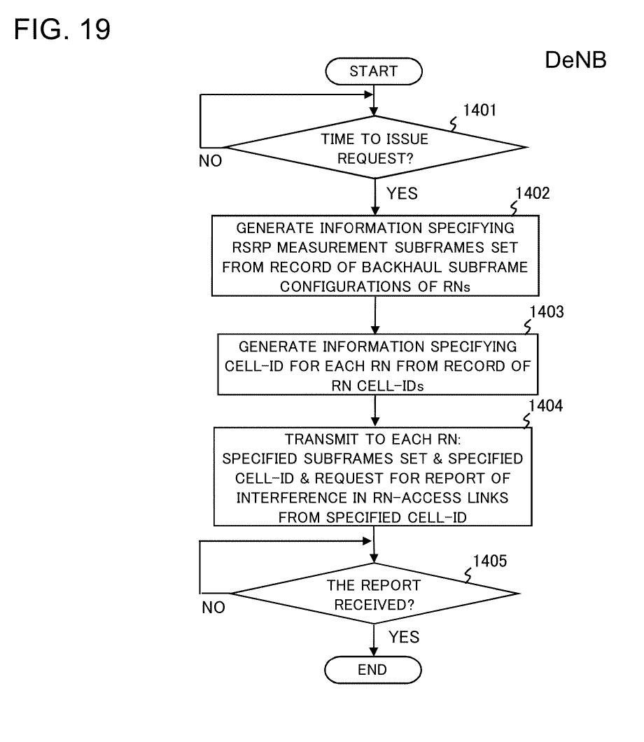

Referring to FIG. 19, the scheduler 105 checks whether it is time to issue a request for report on interference (operation 1401). Time to issue the request can be controlled by operator. Alternatively, the request can be issued periodically, when the number of RNs and/or RN-UEs exceeds a predefined value, or when there is a change of backhaul subframe configurations of RNs. When it is time to issue a request for report on interference (operation 1401; YES), the RL-interference report controller 107 generates information specifying RSRP measurement subframe set from the record of backhaul subframe configurations of RNs (operation 1402) and generates information specifying cell-IDs for each RN from the record of RN Cell-IDs (operation 1403). Thereafter, the scheduler 105 transmits to each RN the specified subframe set, the specified Cell-IDs and the request for report of interference in RN-access links from nodes with the specified Cell-IDs (operation 1404). Thereafter, the scheduler 105 enters a state of waiting for a report of interference (operation 1405). Operations after receiving the report from each RN (operation 1405; YES) are similar to those in the third illustrative embodiment.

### 4.3) RN Operation

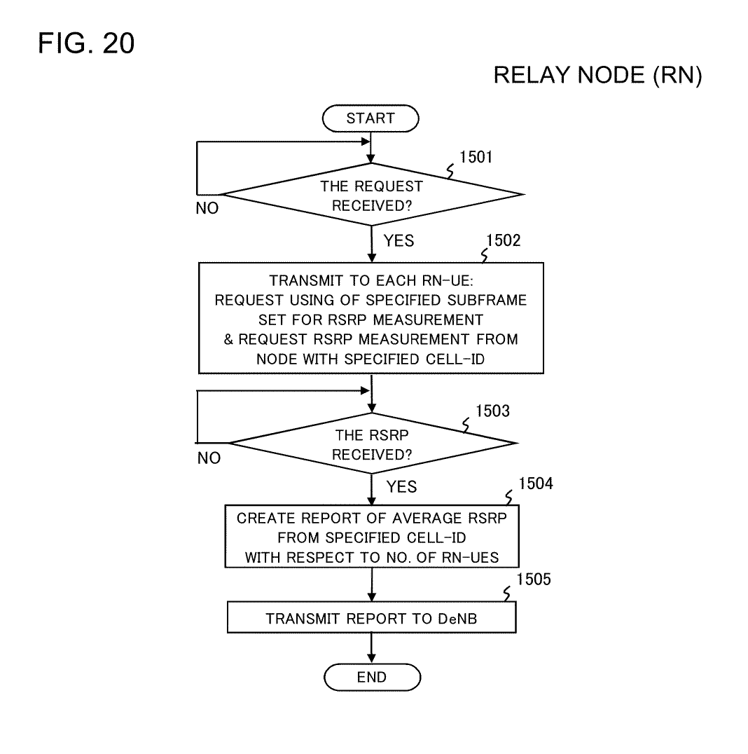

Referring to FIG. 20, when receiving the request from the DeNB 10 (operation 1501; YES), the RL-interference report generator 207 sends to each RN-UE a request for use of specified subframe set for RSRP measurement and a request for measurement of RSRP from nodes with the specified Cell-IDs (operation 1502).

When receiving the measured RSRPs from the respective RN-UEs (operation 1503; YES), the RL-interference report generator 207 calculates average RSRP from each specified Cell-ID with respect to the number of RN-UEs to create a report of the calculation results (operation 1504) and sends the report to the DeNB 10 (operation 1505).

### 4.4) Advantageous Effect

As described above, according to the fourth illustrative embodiment, the DeNB can know interference level between RN-access links as in the first illustrative embodiment. Therefore the DeNB 10 can minimize interference level between RN-access links, allowing the optimum backhaul subframe coordination that maximizes the capacity of the RN.

In addition, the DeNB specifies for each RN a set of non-backhaul subframes for RN-UEs to measure RSRP, also specifies Cell-IDs based on a record of RN Cell-IDs, and request each RN to report interferences in RN-access links from nodes with the specified Cell-IDs. Each RN requests RN-UEs to use the specified set of non-backhaul subframes for RSRP measurement, acquires from RN-UEs RSRPs from respective nodes with the specified Cell-IDs, and sends a report to the DeNB. Accordingly, compared to the first illustrative embodiment, RSRP can be specified to measure at subframes subjected to the same level of interference, allowing improved accuracy of measurement of interference level between RN-access links and improved accuracy of minimization of interference level between RN-access links.

### 4.5) Variations

Specifying set of subframes for RSRP measurement as described above can also be applied to the second and third illustrative embodiments.

### INDUSTRIAL APPLICABILITY

The present invention can be applied to a communication system with relay nodes.

### 5. Supplementary Notes

### (Supplementary Note 1)

A communication system comprising a plurality of communication nodes which includes a base station and a plurality of relay nodes, wherein the base station controls the relay nodes, each of which can provide a radio connection to at least one terminal via an access link,

wherein the base station signals each of the relay nodes to report measurement information related to the access link.

### (Supplementary Note 2)

The communication system of supplementary note 1, wherein each relay node sends the base station a report on the measurement information of interference in the access link received from another communication node.

### (Supplementary Note 3)

The communication system of supplementary note 2, wherein the base station identifies the interference in the access link from which of the relay nodes based on cell-IDs of the relay nodes.

### (Supplementary Note 4)

The communication system of supplementary note 3, wherein the base station specifies cell-IDs of communication nodes for each relay node, and requests each relay node to report the interference in the access link from communication nodes with the specified cell-IDs.

### (Supplementary Note 5)

The communication system of supplementary note 4, wherein each relay node, upon reception of the specified Cell-IDs and the request, acquires from the terminal measurement results of reference signal received power (RSRP) from the communication nodes with the specified Cell-IDs, creates the report based on the RSRP measurement results, and sends the report to the base station.

### (Supplementary Note 6)

The communication system of supplementary note 4, wherein each relay node acquires from the terminal measurement results of reference signal received power (RSRP) from other communication nodes and stores the RSRP measurement results, wherein when receiving the request, the relay node creates the report based on the stored RSRP measurement results and the specified cell-IDs, and sends the report to the base station.

### (Supplementary Note 7)

The communication system of supplementary note 3, wherein the base station notifies each relay node of relay-node indicating information for identifying which communication nodes are relay nodes, and separately requests each relay node to report the interferences in the access links from relay nodes indicated by the relay-node indicating information.

### (Supplementary Note 8)

The communication system of supplementary note 7, wherein each relay node stores the relay-node indicating information received from the base station.

### (Supplementary Note 9)

The communication system of supplementary note 7 or 8, wherein each relay node, upon reception of the request, acquires from the terminal measurement results of reference signal received power (RSRP) from the relay nodes included in the storage of the notified information, creates the report based on the RSRP measurement results, and sends the report to the base station.

### (Supplementary Note 10)

The communication system of supplementary note 7 or 8, wherein each relay node acquires from the terminal measurement results of reference signal received power (RSRP) from the relay nodes included in the storage of the notified information and stores the RSRP measurement results, wherein when receiving the request, the relay node creates the report based on the stored RSRP measurement results, and sends the report to the base station.

### (Supplementary Note 11)

The communication system of supplementary note 3, wherein the base station requests each relay node to report interference in the access link from an adjacent communication node and, when receiving the report, identifies the interference in the access link from an adjacent relay node based on the cell-IDs.

### (Supplementary Note 12)

The communication system of supplementary note 11, wherein each relay node, upon reception of the request, acquires from the terminal measurement results of reference signal received power (RSRP) from the adjacent communication node, creates the report based on the RSRP measurement results, and sends the report to the base station.

### (Supplementary Note 13)

The communication system of supplementary note 11, wherein each relay node acquires from the terminal measurement results of reference signal received power (RSRP) from the adjacent communication node and stores the RSRP measurement results, wherein when receiving the request, the relay node creates the report based on the stored RSRP measurement results, and sends the report to the base station.

### (Supplementary Note 14)

The communication system of one of supplementary notes 4 to 13, wherein the base station specifies for each relay node a set of subframes for the terminal to measure the interference based on backhaul subframe configurations of relay nodes, wherein each relay node requests the terminal to use the specified set of subframes for the measurement of interference.

### (Supplementary Note 15)

The communication system of one of supplementary notes 2 to 14, wherein each relay node creates the report based on statistical property of the measurement information of interference.

### (Supplementary Note 16)

A communication method in a communication system comprising a plurality of communication nodes which includes a base station and a plurality of relay nodes, wherein the base station controls the relay nodes, each of which can provide a radio connection to at least one terminal via an access link, the communication method comprising:

at the base station,

signaling each of the relay nodes to report measurement information related to the access link; and

receiving a report on the measurement information from each relay node.

### (Supplementary Note 17)

The communication method of supplementary note 16, further comprising:

at each relay node,

sending the base station the report on the measurement information of interference in the access link received from another communication node.

### (Supplementary Note 18)

The communication method of supplementary note 17, further comprising:

at the base station,

identifying the interference in the access link from which of the relay nodes based on cell-IDs of the relay nodes.

### (Supplementary Note 19)

The communication method of supplementary note 18, wherein the signaling step of the base station comprising:

specifying cell-IDs of communication nodes for each relay node; and

requesting each relay node to report the interference in the access link from communication nodes with the specified cell-IDs.

### (Supplementary Note 20)

The communication method of supplementary note 19, wherein

at each relay node,

receiving the specified Cell-IDs and the request from the base station;

acquiring from the terminal measurement results of reference signal received power (RSRP) from the communication nodes with the specified Cell-IDs;

creating the report based on the RSRP measurement results; and

sending the report to the base station.

### (Supplementary Note 21)

The communication method of supplementary note 19, wherein

at each relay node,

acquiring from the terminal measurement results of reference signal received power (RSRP) from other communication nodes;

storing the RSRP measurement results;

when receiving the request, creating the report based on the stored RSRP measurement results and the specified cell-IDs; and

sending the report to the base station.

### (Supplementary Note 22)

The communication method of supplementary note 18, wherein the signaling step of the base station comprising:

notifying each relay node of relay-node indicating information for identifying which communication nodes are relay nodes; and

separately requesting each relay node to report the interferences in the access links from relay nodes indicated by the relay-node indicating information.

### (Supplementary Note 23)

The communication method of supplementary note 22, further comprising:

at each relay node,

storing the relay-node indicating information received from the base station.

### (Supplementary Note 24)

The communication method of supplementary note 22 or 23, wherein

at each relay node,

receiving the request;

acquiring from the terminal measurement results of reference signal received power (RSRP) from the relay nodes included in the storage of the notified information;

creating the report based on the RSRP measurement results; and

sending the report to the base station.

### (Supplementary Note 25)

The communication method of supplementary note 22 or 23, wherein

at each relay node,

acquiring from the terminal measurement results of reference signal received power (RSRP) from the relay nodes included in the storage of the notified information;

storing the RSRP measurement results;

when receiving the request, creating the report based on the stored RSRP measurement results; and

sending the report to the base station.

### (Supplementary Note 26)

The communication method of supplementary note 18, wherein the signaling step of the base station comprising:

requesting each relay node to report interference in the access link from an adjacent communication node; and

when receiving the report, identifying the interference in the access link from an adjacent relay node based on the cell-IDs.

### (Supplementary Note 27)

The communication method of supplementary note 26, wherein further comprising:

at each relay node,

receiving the request;

acquiring from the terminal measurement results of reference signal received power (RSRP) from the adjacent communication node;

creating the report based on the RSRP measurement results; and

sending the report to the base station.

### (Supplementary Note 28)

The communication method of supplementary note 26, wherein

at each relay node,

acquiring from the terminal measurement results of reference signal received power (RSRP) from the adjacent communication node;

storing the RSRP measurement results;

when receiving the request, creating the report based on the stored RSRP measurement results; and

sending the report to the base station.

### (Supplementary Note 29)

The communication method of one of supplementary notes 19 to 28, wherein the base station specifies for each relay node a set of subframes for the terminal to measure the interference based on backhaul subframe configurations of relay nodes, wherein each relay node requests the terminal to use the specified set of subframes for the measurement of interference.

### (Supplementary Note 30)

The communication method of one of supplementary notes 19 to 29, wherein each relay node creates the report based on statistical property of the measurement information of interference.

### (Supplementary Note 31)

A relay node device in a communication system comprising a plurality of communication node devices including a base station and a plurality of relay node devices, comprising:

a first radio communication section for providing a first radio connection to the base station via a first link;

a second radio communication section for providing a second radio connection to at least one terminal via a second link; and

a controller for generating a report on measurement information related to the second link and sending the report to the base station according to signaling from the base station.

### (Supplementary Note 32)

The relay node device of supplementary note 31, wherein the measurement information is information of interference in the second link received from another communication node device.

### (Supplementary Note 33)

The relay node device of supplementary note 32, wherein the communication node devices including the base station and the relay node devices are identified by respective cell-IDs.

### (Supplementary Note 34)

The relay node device of supplementary note 33, wherein the controller receives from the base station specified cell-IDs of communication node devices and a request for reporting the interference in the second link from communication node devices with the specified cell-IDs.

### (Supplementary Note 35)

The relay node device of supplementary note 34, wherein upon reception of the specified Cell-IDs and the request, the controller acquires from the terminal measurement results of reference signal received power (RSRP) from the communication node devices with the specified Cell-IDs, creates the report based on the RSRP measurement results, and sends the report to the base station.

### (Supplementary Note 36)

The relay node device of supplementary note 34, wherein the controller acquires from the terminal measurement results of reference signal received power (RSRP) from other communication node devices and stores the RSRP measurement results, wherein when receiving the request, the controller creates the report based on the stored RSRP measurement results and the specified cell-IDs, and sends the report to the base station.

### (Supplementary Note 37)

The relay node device of supplementary note 33, wherein the controller is notified by the base station of relay-node indicating information for identifying which communication node devices are relay nodes, wherein the controller is separately requested to report the interferences in the second links from relay node devices indicated by the relay-node indicating information.

### (Supplementary Note 38)

The relay node device of supplementary note 37, wherein the relay-node indicating information received from the base station is stored.

### (Supplementary Note 39)

The relay node device of supplementary note 37 or 38, wherein the controller, upon reception of the request, acquires from the terminal measurement results of reference signal received power (RSRP) from the relay node devices included in the storage of the notified information, creates the report based on the RSRP measurement results, and sends the report to the base station.

### (Supplementary Note 40)

The relay node device of supplementary note 37 or 38, wherein the controller acquires from the terminal measurement results of reference signal received power (RSRP) from the relay node devices included in the storage of the notified information and stores the RSRP measurement results, wherein when receiving the request, the controller creates the report based on the stored RSRP measurement results, and sends the report to the base station.

### (Supplementary Note 41)

The relay node device of supplementary note 33, wherein the controller is requested by the base station to report interference in the second link from an adjacent communication node device.

### (Supplementary Note 42)

The relay node device of supplementary note 41, wherein the controller, upon reception of the request, acquires from the terminal measurement results of reference signal received power (RSRP) from the adjacent communication node device, creates the report based on the RSRP measurement results, and sends the report to the base station.

### (Supplementary Note 43)

The relay node device of supplementary note 41, wherein the controller acquires from the terminal measurement results of reference signal received power (RSRP) from the adjacent communication node device and stores the RSRP measurement results, wherein when receiving the request, the controller creates the report based on the stored RSRP measurement results, and sends the report to the base station.

### (Supplementary Note 44)

The relay node device of one of supplementary notes 34 to 43, wherein a set of subframes for the terminal to measure the interference based on first-link subframe configurations of relay node devices is specified by the base station, wherein the controller requests the terminal to use the specified set of subframes for the measurement of interference.

### (Supplementary Note 45)

The relay node device of one of supplementary notes 34 to 44, wherein the controller creates the report based on statistical property of the measurement information of interference.

### (Supplementary Note 46)

A terminal device in a communication system comprising a plurality of communication node devices including a base station and a plurality of relay node devices, comprising:

a radio communication section for providing a radio connection to a relay node device via an access link;

a controller for generating measurement information related to the access link and sending the measurement information to the relay node device in response to a request received from the relay node controlled by the base station.

### (Supplementary Note 47)

The terminal device of supplementary note 46, wherein the measurement information is obtained by measuring interference in the access link received from another communication node device.

### (Supplementary Note 48)

The terminal device of supplementary note 47, wherein the communication node devices including the base station and the relay node devices are identified by respective cell-IDs.

### (Supplementary Note 49)

The terminal device of supplementary note 48, wherein the controller receives from the relay node device specified cell-IDs of communication node devices and the request for the interference in the access link from communication node devices with the specified cell-IDs.

### (Supplementary Note 50)

The terminal device of supplementary note 49, wherein upon reception of the specified Cell-IDs and the request, the controller generates measurement results of reference signal received power (RSRP) from the communication node devices with the specified Cell-IDs and sends the RSRP measurement results to the relay node device.

### (Supplementary Note 51)

The terminal device of supplementary note 48, wherein the controller is requested by the relay node device to generate measurement results of interference in the access link from interfering communication node devices and send the measurement results and cell-IDs of the interfering communication node devices to the relay node device.

### (Supplementary Note 52)

The terminal device of supplementary note 51, wherein the measurement results is reference signal received power (RSRP) from interfering communication node devices.

### (Supplementary Note 53)

The terminal device of one of supplementary notes 49 to 52, wherein the controller measures the interference based on backhaul subframe configurations of relay node devices according to a set of subframes specified by the relay node device.

### (Supplementary Note 54)

A base station in a communication system comprising a plurality of communication nodes which includes the base station and a plurality of relay nodes, each of which can provide a radio connection to at least one terminal via an access link, comprising:

a radio communication section for communicating with the relay nodes; and

a controller for signaling each of the relay nodes to report measurement information related to the access link.

### (Supplementary Note 55)

The base station of supplementary note 54, wherein the controller receives from each relay node a report on the measurement information of interference in the access link received from another communication node.

### (Supplementary Note 56)

The base station of supplementary note 55, wherein the controller identifies the interference in the access link from which of the relay nodes based on cell-IDs of the relay nodes.

### (Supplementary Note 57)

A control method of a relay node device in a communication system comprising a plurality of communication node devices including a base station and a plurality of relay node devices, comprising:

providing a first radio connection to the base station via a first link;

providing a second radio connection to at least one terminal via a second link; and

generating a report on measurement information related to the second link and sending the report to the base station according to signaling from the base station.

### REFERENCE SIGNS LIST

10 Base station (DeNB)
11 DeNB cell
20 Relay node (RN)
30 User equipment (UE)

1. A communication system comprising a plurality of communication nodes which includes a base station and a plurality of relay nodes, wherein the base station controls the relay nodes, each of which can provide a radio connection to at least one terminal via an access link,
wherein the base station signals each of the relay nodes to report measurement information related to the access link.

2. The communication system of claim 1, wherein each relay node sends the base station a report on the measurement information of interference in the access link received from another communication node.

3. The communication system of claim 2, wherein the base station identifies the interference in the access link from which of the relay nodes based on cell-IDs of the relay nodes.

4. The communication system of claim 3, wherein the base station specifies cell-IDs of communication nodes for each relay node, and requests each relay node to report the interference in the access link from communication nodes with the specified cell-IDs.

5. The communication system of claim 4, wherein each relay node, upon reception of the specified Cell-IDs and the request, acquires from the terminal measurement results of reference signal received power (RSRP) from the communication nodes with the specified Cell-IDs, creates the report based on the RSRP measurement results, and sends the report to the base station.

6. The communication system of claim 4, wherein each relay node acquires from the terminal measurement results of reference signal received power (RSRP) from other communication nodes and stores the RSRP measurement results, wherein when receiving the request, the relay node creates the report based on the stored RSRP measurement results and the specified cell-IDs, and sends the report to the base station.

7. The communication system of claim 3, wherein the base station notifies each relay node of relay-node indicating information for identifying which communication nodes are relay nodes, and separately requests each relay node to report the interferences in the access links from relay nodes indicated by the relay-node indicating information.

8. The communication system of claim 7, wherein each relay node stores the relay-node indicating information received from the base station.

9. The communication system of claim 7, wherein each relay node, upon reception of the request, acquires from the terminal measurement results of reference signal received power (RSRP) from the relay nodes included in the storage of the notified information, creates the report based on the RSRP measurement results, and sends the report to the base station.

10. The communication system of claim 7, wherein each relay node acquires from the terminal measurement results of reference signal received power (RSRP) from the relay nodes included in the storage of the notified information and stores the RSRP measurement results, wherein when receiving the request, the relay node creates the report based on the stored RSRP measurement results, and sends the report to the base station.

11. The communication system of claim 3, wherein the base station requests each relay node to report interference in the access link from an adjacent communication node and, when receiving the report, identifies the interference in the access link from an adjacent relay node based on the cell-IDs.

12. The communication system of claim 11, wherein each relay node, upon reception of the request, acquires from the terminal measurement results of reference signal received power (RSRP) from the adjacent communication node, creates the report based on the RSRP measurement results, and sends the report to the base station.

13. The communication system of claim 11, wherein each relay node acquires from the terminal measurement results of reference signal received power (RSRP) from the adjacent communication node and stores the RSRP measurement results, wherein when receiving the request, the relay node creates the report based on the stored RSRP measurement results, and sends the report to the base station.

14. The communication system of claim 4, wherein the base station specifies for each relay node a set of subframes for the terminal to measure the interference based on backhaul subframe configurations of relay nodes, wherein each relay node requests the terminal to use the specified set of subframes for the measurement of interference.

15. The communication system of claim 2, wherein each relay node creates the report based on statistical property of the measurement information of interference.

16. A communication method in a communication system comprising a plurality of communication nodes which includes a base station and a plurality of relay nodes, wherein the base station controls the relay nodes, each of which can provide a radio connection to at least one terminal via an access link, the communication method comprising:
at the base station,
signaling each of the relay nodes to report measurement information related to the access link; and
receiving a report on the measurement information from each relay node.

17. The communication method of claim 16, further comprising:
at each relay node,
sending the base station the report on the measurement information of interference in the access link received from another communication node.

18. The communication method of claim 17, further comprising:
at the base station,
identifying the interference in the access link from which of the relay nodes based on cell-IDs of the relay nodes.

19. A relay node device in a communication system comprising a plurality of communication node devices including a base station and a plurality of relay node devices, comprising:
a first radio communication section for providing a first radio connection to the base station via a first link;
a second radio communication section for providing a second radio connection to at least one terminal via a second link; and
a controller for generating a report on measurement information related to the second link and sending the report to the base station according to signaling from the base station.

20. The relay node device of claim 19, wherein the measurement information is information of interference in the second link received from another communication node device.

21. The relay node device of claim 20, wherein the communication node devices including the base station and the relay node devices are identified by respective cell-IDs.

22. The relay node device of claim 21, wherein the controller receives from the base station specified cell-IDs of communication node devices and a request for reporting the interference in the second link from communication node devices with the specified cell-IDs.

23. The relay node device of claim 22, wherein upon reception of the specified Cell-IDs and the request, the controller acquires from the terminal measurement results of reference signal received power (RSRP) from the communication node devices with the specified Cell-IDs, creates the report based on the RSRP measurement results, and sends the report to the base station.

24. The relay node device of claim 22, wherein the controller acquires from the terminal measurement results of reference signal received power (RSRP) from other communication node devices and stores the RSRP measurement results, wherein when receiving the request, the controller creates the report based on the stored RSRP measurement results and the specified cell-IDs, and sends the report to the base station.

25. The relay node device of claim 21, wherein the controller is notified by the base station of relay-node indicating information for identifying which communication node devices are relay nodes, wherein the controller is separately requested to report the interferences in the second links from relay node devices indicated by the relay-node indicating information.

26. The relay node device of claim 25, wherein the relay-node indicating information received from the base station is stored.

27. The relay node device of claim 25, wherein the controller, upon reception of the request, acquires from the terminal measurement results of reference signal received power (RSRP) from the relay node devices included in the storage of the notified information, creates the report based on the RSRP measurement results, and sends the report to the base station.

28. The relay node device of claim 25, wherein the controller acquires from the terminal measurement results of reference signal received power (RSRP) from the relay node devices included in the storage of the notified information and stores the RSRP measurement results, wherein when receiving the request, the controller creates the report based on the stored RSRP measurement results, and sends the report to the base station.

29. The relay node device of claim 21, wherein the controller is requested by the base station to report interference in the second link from an adjacent communication node device.

30. The relay node device of claim 29, wherein the controller, upon reception of the request, acquires from the terminal measurement results of reference signal received power (RSRP) from the adjacent communication node device, creates the report based on the RSRP measurement results, and sends the report to the base station.

31. The relay node device of claim 29, wherein the controller acquires from the terminal measurement results of reference signal received power (RSRP) from the adjacent communication node device and stores the RSRP measurement results, wherein when receiving the request, the controller creates the report based on the stored RSRP measurement results, and sends the report to the base station.

32. The relay node device of claim 22, wherein a set of subframes for the terminal to measure the interference based on first-link subframe configurations of relay node devices is specified by the base station, wherein the controller requests the terminal to use the specified set of subframes for the measurement of interference.

33. The relay node device of claim 22, wherein the controller creates the report based on statistical property of the measurement information of interference.

34. (canceled)

35. (canceled)

36. (canceled)

37. (canceled)

38. (canceled)

39. (canceled)

40. (canceled)

41. (canceled)

42. (canceled)

43. (canceled)
